(19) United States
(12) Patent Application Publication
(10) Pub. No.: US 2025/0208359 A1
(43) Pub. Date: Jun. 26, 2025

(54) CONNECTOR FOR OPTICAL FIBER ALIGNMENT

(71) Applicant: Taiwan Semiconductor Manufacturing Co., Ltd., Hsinchu (TW)

(72) Inventors: Tai-Chun Huang, Hsinchu (TW); Stefan Rusu, Sunnyvale, CA (US)

(21) Appl. No.: 18/616,604

(22) Filed: Mar. 26, 2024

Related U.S. Application Data
(60) Provisional application No. 63/612,522, filed on Dec. 20, 2023.

(51) Int. Cl. G02B 6/38

(52) U.S. Cl. CPC G02B 6/3886; G02B 6/3825

(57) ABSTRACT

A device includes a first fiber array that includes first optical fibers and first magnetic members; a second fiber array that includes second optical fibers and second magnetic members; and a connector including third magnetic members adjacent an opening, wherein the opening extends from a first side of the connector to a second side of the connector, wherein the first magnetic members of the first fiber array correspond to third magnetic members near the first side, wherein the second magnetic members of the second fiber array correspond to third magnetic members near the second side.

### PRIORITY CLAIM AND CROSS-REFERENCE

This application claims the benefit of U.S. Provisional Application No. 63/612,522, filed on Dec. 20, 2023, which application is hereby incorporated herein by reference.

### BACKGROUND

Electrical signaling and processing are one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Improvements in each of these long-range optical components and short-range electrical components are desired.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a three-dimensional view of a connector for optical fibers, in accordance with some embodiments.

FIG. 2A illustrates a top-down cross-sectional view of a connector and fiber arrays prior to connection, in accordance with some embodiments.

FIG. 2B illustrates a top-down cross-sectional view of a connector and fiber arrays after connection, in accordance with some embodiments.

FIG. 2C illustrates a top-down cross-sectional view of a connector and fiber arrays after disconnection, in accordance with some embodiments.

FIGS. 3A and 3B illustrate configurations of magnetic members of a connector and fiber arrays, in accordance with some embodiments.

FIG. 4 illustrates a cross-sectional view of a fiber array after insertion into a connector, in accordance with some embodiments.

FIGS. 5A and 5B illustrate connectors and fiber arrays having different configurations of magnetic members, in accordance with some embodiments.

FIG. 6 illustrates a cross-sectional view of a connector, in accordance with some embodiments.

FIGS. 7A and 7B illustrate cross-sectional views of a connector and fiber arrays after connection, in accordance with some embodiments.

FIG. 8 illustrates a cross-sectional view of a connector and fiber arrays after connection, in accordance with some embodiments.

FIG. 9 illustrates a cross-sectional view of a connector and fiber arrays after connection, in accordance with some embodiments.

FIGS. 10A and 10B illustrate views of a fiber array structure comprising a flat connector, in accordance with some embodiments.

FIG. 11A illustrates a cross-sectional view of fiber array structures prior to connection, in accordance with some embodiments.

FIG. 11B illustrates a cross-sectional view of fiber array structures after connection, in accordance with some embodiments.

FIG. 12 illustrates a plan view of fiber array structures after connection, in accordance with some embodiments.

FIG. 13 illustrates a package connected to a vertical fiber array by a connector, in accordance with some embodiments.

FIG. 14 illustrates a package connected to a horizontal fiber array by a connector, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments are described herein in which magnets are used to automatically align and connect optical fibers within a connector. Embodiments are also described herein in which springs are used to secure optical fibers within a connector and allow for adjustment of the alignment of the optical fibers. The connectors described herein allow the connected optical fibers to be disconnected and reconnected. In this manner, optical fibers may be replaced or repaired more efficiently. The embodiments described herein, however, are intended to be illustrative and are not intended to be limiting. Rather, the ideas presented may be implemented in a wide variety of embodiments, and all such embodiments are fully intended to be included within the scope of the disclosure.

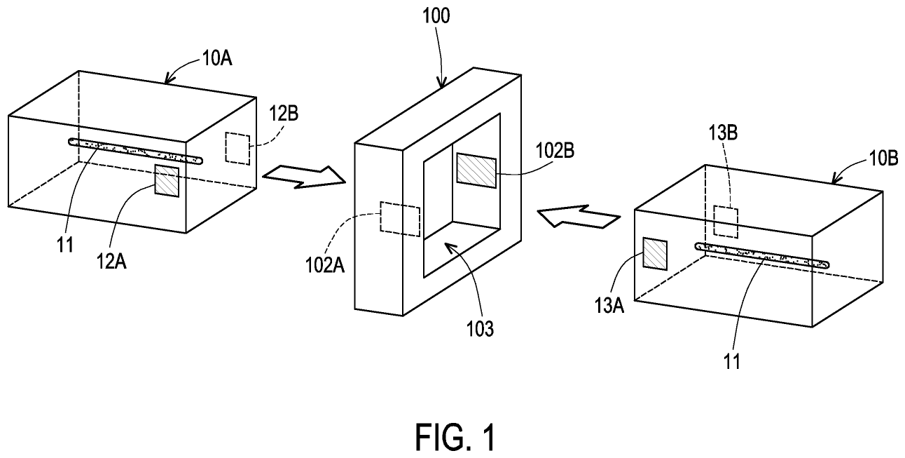

FIG. 1 illustrates a three-dimensional view of a connector 100 for optical fibers, in accordance with some embodiments. FIG. 1 also illustrates two unconnected fiber arrays 10A and 10B that may be inserted into the connector 100 to be connected. The connector 100 is configured to hold the two fiber arrays 10A-B such that the fiber arrays 10A-B are optically coupled to each other, for example, so that optical signals and/or optical power may be transmitted between the fiber arrays 10A-B. The connector 100 described herein securely holds the fiber arrays 10A-B but also allows the fiber arrays 10A-B to be detached, if desired. The connector 100 and fiber arrays 10A-B illustrated in FIG. 1 and other figures are representative examples, and other configurations, arrangements, or features are possible.

The fiber arrays 10A-B may be structures that each comprise one or more optical fibers 11, such as fiber array units, ferrules, substrates, holders, or other suitable components configured to hold optical fibers 11. A single optical fiber 11 is shown in each of the fiber arrays 10A-B in FIG. 1, but each fiber array 10A-B may comprise any suitable number of optical fibers 11 in any suitable arrangement. The optical fibers 11 may extend away from the fiber arrays 10A-B (not shown), with the illustrated portions of the fiber arrays 10A-B comprising ends of the optical fibers 11. In this manner, connecting the fiber arrays 10A-B using the connector 100 may facilitate end-to-end optical coupling of the optical fibers 11 of the fiber array 10A to the optical fibers 11 of the fiber array 10B. In some embodiments, the fiber array 10A comprises one or more magnetic members 12 (e.g. magnetic members 12A and 12B) and the fiber array 10B comprises one or more magnetic members 13 (e.g., magnetic members 13A and 13B), described in greater detail below. In some embodiments, the fiber array 10A may have different dimensions (e.g., a different thickness) than the fiber array 10B.

As shown in FIG. 1, the connector 100 may comprise a ring-shaped member having an opening 103 within which the fiber arrays 10A-B may be inserted for connection. Accordingly, the opening 103 of the connector 100 may be slightly larger than the fiber arrays 10A or 10B to be connected. For example, the opening 103 shown in FIG. 1 has a rectangular shape corresponding to the rectangular shapes of the fiber arrays 10A-B, but other shapes are possible. In some embodiments, the opening 103 may have different dimensions on different sides of the connector 100, with the dimensions of each side of the opening 103 corresponding to the dimensions of the fiber array 10A or 10B inserted into that side.

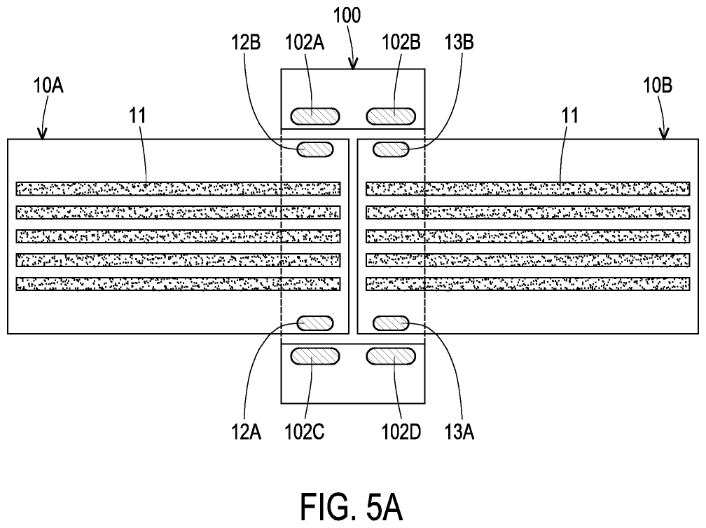

In some embodiments, the connector 100 comprises magnetic members 102 located at laterally opposite sidewalls of the opening 103. For example, FIG. 1 illustrates one magnetic member 102A on a first vertical sidewall of the opening 103, and another magnetic member 102B on a second vertical sidewall of the opening 103 that faces the first vertical sidewall. The magnetic members 102 are magnets comprising one or more suitable magnetic materials. FIG. 1 shows a single magnetic member 102 at each sidewall, but multiple magnetic members 102 may be present at each sidewall (see, e.g., FIGS. 5A-5B). The magnetic members 102 may be exposed or may be beneath (e.g., covered by) the sidewall surfaces. The magnetic members 102 may protrude from the sidewall surfaces, may be level with the sidewall surfaces, or may be recessed from the sidewall surfaces.

The magnetic members 102 are utilized to provide improved alignment of the fiber arrays 10A-B while also allowing the fiber arrays 10A-B to be disconnected from the connector 100. The magnetic members 102 are configured to magnetically attract corresponding magnetic members on the fiber arrays 10A-B. For example, as shown in FIG. 1, the fiber array 10A comprises magnetic members 12 on laterally opposite sidewalls, shown as magnetic members 12A and 12B, and the fiber array 10B comprises magnetic members 13 on laterally opposite sidewalls, shown as magnetic members 13A and 13B. The magnetic members 12 of the fiber array 10A and the magnetic members 13 of the fiber array 10B may collectively be referred to herein as “magnetic members 12/13,” and the magnetic members 102 of the connector 100 and the magnetic members 12/13 may collectively be referred to herein as “magnetic members 102/12/013.” The magnetic members 12/13 are magnets comprising one or more suitable magnetic materials. FIG. 1 shows a single magnetic member 12 at each sidewall of the fiber array 10A and a single magnetic member 13 at each sidewall of the fiber array 10B, but multiple magnetic members 12/13 may be present at each sidewall (see, e.g., FIGS. 5A-5B). The magnetic members 102 may be exposed or may be beneath (e.g., covered by) the sidewall surfaces. The magnetic members 102 may protrude from the sidewall surfaces, may be level with the sidewall surfaces, or may be recessed from the sidewall surfaces.

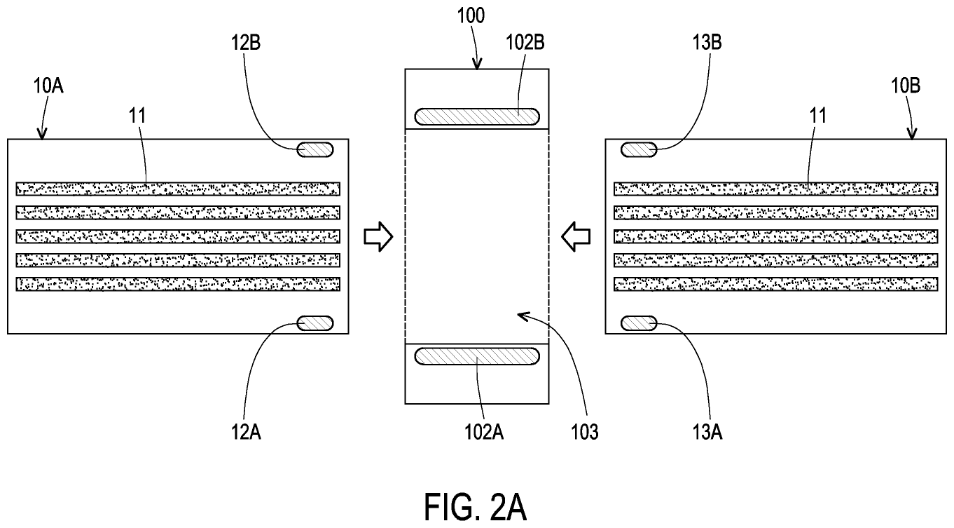

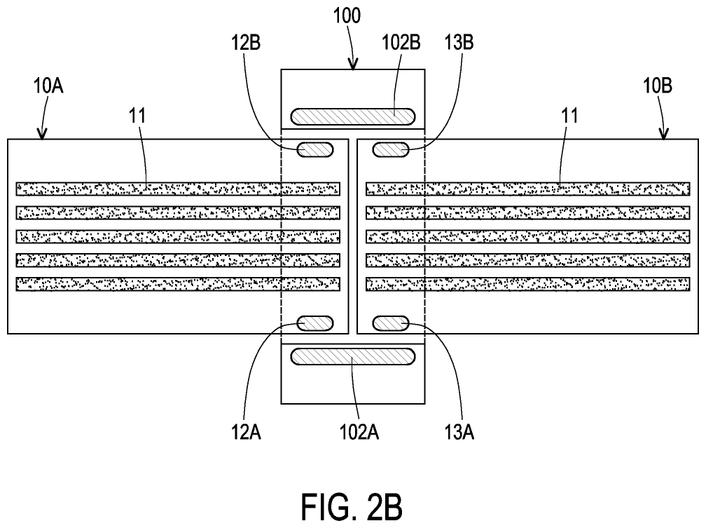

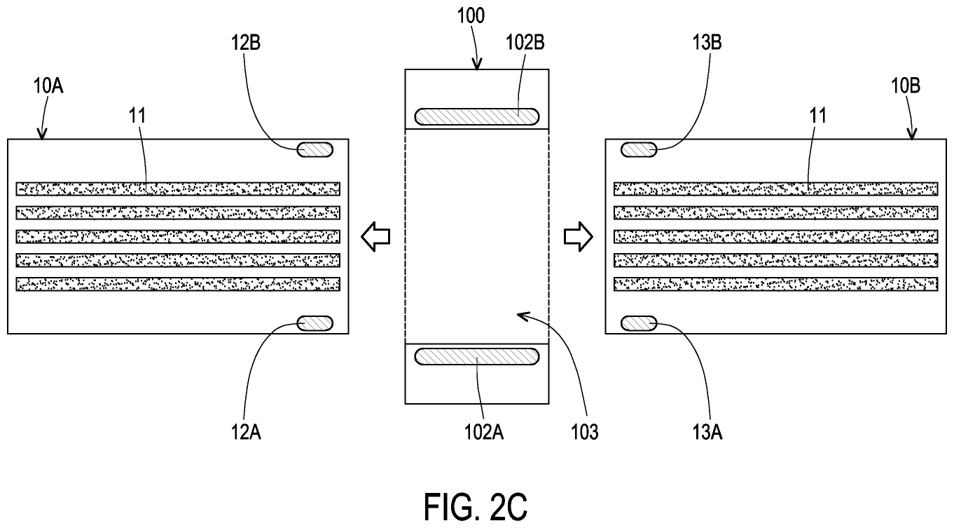

FIGS. 2A, 2B, and 2C illustrate top-down cross-sectional views of a connector 100 and fiber arrays 10A-B, in accordance with some embodiments. FIG. 2A illustrates the fiber arrays 10A-B prior to insertion into the connector 100, FIG. 2B illustrates the fiber arrays 10A-B after being connected by the connector 100, and FIG. 2C illustrates the fiber arrays 10A-B after being disconnected and removed from the connector 100, in accordance with some embodiments. The connector 100 may be similar to the connector 100 of FIG. 1, and the fiber arrays 10A-B may be similar to the fiber arrays 10A-B of FIG. 1. For example, the connector 100 comprises magnetic members 102A-B at opposite sidewalls of an opening 103, the fiber array 10A comprises magnetic members 12A-B at opposite sidewalls, and the fiber array 10B comprises magnetic members 13A-B at opposite sidewalls.

In FIG. 2A, the fiber arrays 10A-B are brought toward the opening 103 of the connector 100. For example, the fiber array 10A is brought toward a first side of the opening 103 for insertion, and the fiber array 10B is brought toward a second side of the opening 103 for insertion. The fiber arrays 10A-B may be inserted simultaneously or sequentially. As the fiber arrays 10A-B are brought toward the opening 103, attractive magnetic forces between the magnetic members 102A-B and the magnetic members 12/13 pull the fiber arrays 10A-B into the opening 103, facilitating insertion of the fiber arrays 10A-B into the connector 100. For example, the magnetic member 102A of the connector 100 attracts the magnetic member 12A of the fiber array 10A and the magnetic member 13A of the fiber array 10B, and the magnetic member 102B of the connector 100 attracts the magnetic member 12B of the fiber array 10A and the magnetic member 13B of the fiber array 10B. In this manner, the connector 100 allows for easier and more “automatic” connection of fiber arrays 10A-B.

FIG. 2B illustrates the fiber arrays 10A-B after being fully inserted into the connector 100, in accordance with some embodiments. Magnetic forces between the magnetic members 102A-B and the magnetic members 12/13 pull the fiber arrays 10A-B such that the fiber arrays 10A-B become connected within the connector 100. In some embodiments, the magnetic members 102/12/13 are located or arranged such that the magnetic forces position the fiber arrays 10A-B into optical alignment with each other when connected. For example, the magnetic forces may position the fiber arrays 10A-B such that fibers 11 in the fiber array 10A are optically coupled to corresponding fibers 11 in the fiber array 10B, allowing optical signals and/or optical power to be transmitted between the fiber arrays 10A-B. In this manner, the magnetic members 102/12/13 may facilitate easier or more “automatic” optical alignment of the connected fiber arrays 10A-B. Thus, the use of magnetic members 102/12/13 as described herein can allow for faster or more accurate optical alignment of the fiber arrays 10A-B, which can allow for improved quality or improved efficiency of optical fiber transmission.

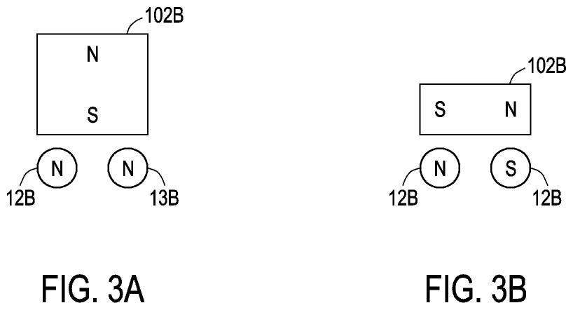

The magnetic members 102, 12, and 13 may have any suitable configuration or arrangement. As an example, FIGS. 3A and 3B illustrate example configurations of magnetic members 102B, 12B, and 13B. Similar configurations may be used for the magnetic members 102A, 12A, and 13A. The view of FIGS. 3A-3B may be a top-down view similar to that of FIG. 2B. FIG. 3A illustrates an embodiment in which the same magnetic pole of the magnetic member 102B is used to attract the magnetic members 12B and 13B. For example, the south pole of the magnetic member 102B attracts the north pole of the magnetic member 12B and the north pole of the magnetic member 13B. The south poles of the magnetic members 12B/13B are not illustrated, and may have any suitable position or arrangement. FIG. 3B illustrates an embodiment in which different magnetic poles of the magnetic member 102B are used to attract the magnetic members 12B and 13B. For example, the south pole of the magnetic member 102B attracts the north pole of the magnetic member 12B, and the north pole of the magnetic member 102B attracts the south pole of the magnetic member 13B. The south pole of the magnetic member 12B and the north pole of the magnetic member 13B are not illustrated, and may have any suitable position or arrangement. In embodiments similar to that shown in FIG. 3B, the magnetic members 12B and 13B may also be attracted to each other by their respective opposite poles, which can facilitate connection and/or alignment of the fiber arrays 10A-B. The configurations and arrangements shown in FIGS. 3A-3B are representative examples, and other arrangements or configurations are possible.

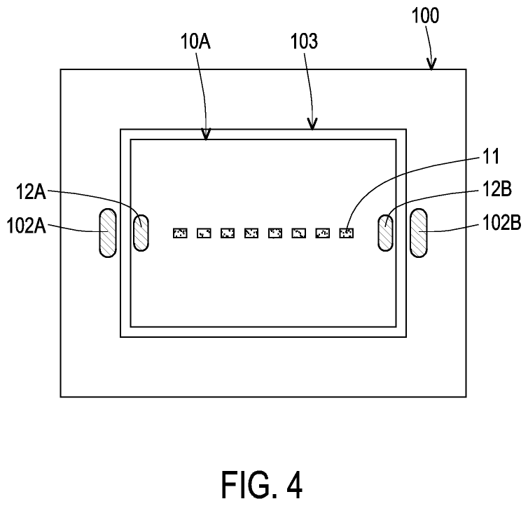

FIG. 4 illustrates a cross-sectional view of the fiber array 10A after insertion into the connector 100, in accordance with some embodiments. The arrangement of magnetic members 102/12 in FIG. 4 is an example, and other arrangements or locations of the magnetic members 102/12/13 are possible. In some embodiments, the fiber arrays 10A-B may be separated from the connector 100 during when connected, as shown in FIGS. 2B and 4. In other embodiments, the fiber arrays 10A-B may physically contact the connector 100 when connected.

Returning to FIG. 2B, the ends of the fiber arrays 10A-B may be separated by a gap when connected by the connector 100, as shown in FIG. 2B, or the ends of the fiber arrays 10A-B may be in physical contact when connected. The magnetic members 12/13 of the fiber arrays 10A-B may be located near the ends of the fiber arrays 10A-B such that the magnetic members 12/13 are at least partially within the opening 103 when the fiber arrays 10A-B are connected. For example, in some embodiments, the magnetic members 12/13 may fully be within the opening 103, as shown in FIG. 2B, and in other embodiments the magnetic members 12/13 may protrude outside of the opening 103 when the fiber arrays 10A-B are connected. The magnetic attraction between the magnetic members 102/12/13 may allow the fiber arrays 10A-B to be securely connected by the connector 100, which can allow for more stable and reliable connections. For example, the magnetic attraction can reduce the chance of fiber arrays 10A-B shifting or being inadvertently disconnected, which can improve the lifespan and durability of the connected fiber arrays 10A-B.

In some embodiments, the use of magnetic members 102/12/13 to secure the fiber arrays 10A-B to the connector 100 can allow the fiber arrays 10A-B to be disconnected if desired. This is shown in FIG. 2C, in which the fiber arrays 10A-B of FIG. 2B have been removed from the connector 100. One or both fiber arrays 10A-B may be detached from the connector 100 for any suitable reason, such as for repair, replacement, disassembly, diagnostic purposes, etc. Enabling easy disconnection of the fiber arrays 10A-B can allow for easier replacement of one or two of the fiber array 10A, the fiber array 10B, or the connector 100 without requiring replacement of all three components, which can reduce time and cost. In this manner, the magnetic members 102/12/13 and the connector 100 described herein can be considered a “modular” system. Further, as the alignment assistance provided by the magnetic members 102/12/13 can make aligning fiber arrays 10A-B easier and more accurate, and the time or effort spent reconnecting fiber arrays 10A-B after disconnection can be reduced, making replacements or repairs more efficient.

A connector 100 may have more magnetic members 102 and the fiber arrays 10A-B may have more magnetic members 12/13 in other embodiments. As non-limiting examples, FIG. 5A illustrates a top-down view of a connector 100 comprising four magnetic members 102A-D, and FIG. 5A illustrates a cross-sectional view of a connector 100 comprising four magnetic members 102A-D and a fiber array 10A comprising four magnetic members 12A-D. The view of FIG. 5A is similar to the view of FIG. 2B, and the view of FIG. 5B is similar to the view of FIG. 4. Connectors 100 or fiber arrays 10A-B may have other numbers or arrangements of magnetic members in other embodiments.

In FIG. 5A, the connector 100 has four magnetic members 102A-D, each of which is used to attract a corresponding magnetic member 12/13 of the fiber arrays 10A-B. For example, during insertion, the magnetic member 102A attracts the magnetic member 12B, the magnetic member 102B attracts the magnetic member 13B, the magnetic member 102C attracts the magnetic member 12A, and the magnetic member 13A attracts the magnetic member 102D. Accordingly, the magnetic members 102A and 102C may be located near one side of the opening 103, and the magnetic members 102B and 102D may be located near the opposite side of the opening 103.

In FIG. 5B, the connector 100 has four magnetic members 102A-D, each of which is used to attract a corresponding magnetic member 12A-D of the fiber array 10A. For example, during insertion, the magnetic members 102A, 102B, 102C, and 102D respectively attract the magnetic members 12A, 12B, 12C, and 12D. Accordingly, multiple magnetic members 102 may be located along the same sidewall of the opening 103, and multiple magnetic members 12 may be located along the same sidewall of the fiber array 10A. The magnetic members 102A-D may be used to attract four corresponding magnetic members 13 of the fiber array 10B, or the connector 100 may have more magnetic members 102 that correspond to magnetic members 13 of the fiber array 10B. In other embodiments, one or more magnetic members 102 may be located along the top and/or bottom sidewalls of the opening 103, or one or more magnetic members 12/13 may be located along the top and/or bottom surfaces of the fiber arrays 10A-B.

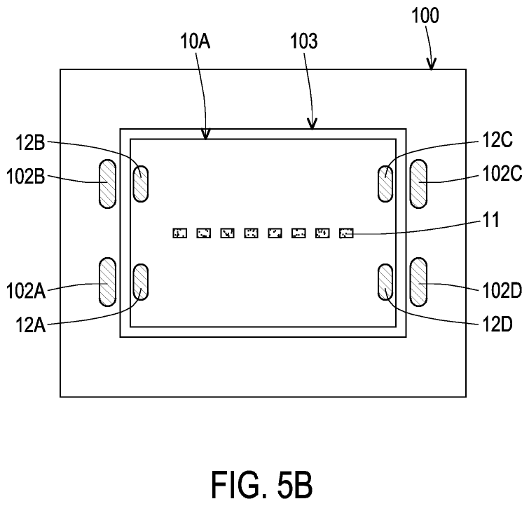

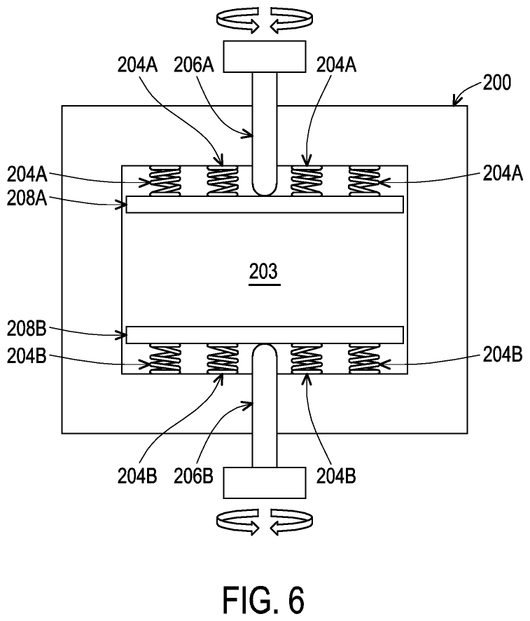

FIG. 6 illustrates a cross-sectional view of an adjustable connector 200 configured to connect fiber arrays, in accordance with some embodiments. FIG. 6 illustrates an end view of a connector 200, similar to the view shown in FIG. 4. In some embodiments, a connector 200 secures two fiber arrays (e.g., fiber arrays 210A-B of FIGS. 7A-7B) such that the fiber arrays are optically coupled and optical signals and/or optical power may be transmitted between the fiber arrays. The connector 200 is a ring-shaped structure comprising an opening 203 within which the fiber arrays may be inserted. The fiber arrays may be similar to those described previously for the fiber arrays 10A-B, and may or may not include magnetic members 12/13. The connector 200 allows for vertical adjustment of the fiber arrays after insertion, described in greater detail below.

The connector 200 shown in FIG. 6 comprises an upper plate 208A and a lower plate 208B within the opening 203. The surfaces of the upper plate 208A and the lower plate 208B that face the center of the opening 203 are configured to physically contact an inserted fiber array, and thus the plates 208A-B may be considered “securing members” or the like. The plates 208A-B may have flat surfaces or may have other surface profiles, such as a surface profile shaped to correspond to a shape of an inserted fiber array. One or more upper springs 204A are located between the upper plate 208A and a top surface of the opening 203, and one or more lower springs 204B are located between the lower plate 208B and a bottom surface of the opening 203. In some embodiments, the springs 204A-B are loaded compression springs that exert compressive forces on the plates 208A-B toward the center of the opening 203. For example, the upper springs 204A push the upper plate 208A toward the bottom surface of the opening 203, and the lower springs 204B push the lower plate 208B toward the upper surface of the opening 203. In this manner, a fiber array inserted between the plates 208A-B is compressed by the plates 208A-B due to the forces exerted by the springs 204A-B. Further, the use of spring-loaded compressive plates 208A-B to connect a fiber array as described herein allows for a fiber array to be securely held but also allows the fiber array to be easily removed or replaced.

FIG. 6 shows four upper springs 204A and four lower springs 204B, but any suitable number of springs 204A-B may be utilized. The use of multiple upper springs 204A or multiple lower springs 204B allows for a more uniform compression along the top and bottom of an inserted fiber array. Further, FIG. 6 shows the springs 204A-B as being helical (e.g., coil) springs, but other types of structures that exert a similar force on the plates 208A-B may be used, such as a leaf spring, a serpentine spring, a foam or other compressible material, or the like.

The connector 200 further comprises an upper adjusting member 206A and a lower adjusting member 206B, also referred to herein as an upper adjuster 206A and a lower adjuster 206B, respectively. The upper adjuster 206A protrudes from the top surface of the opening 203 toward the upper plate 208A. The upper adjuster 206A provides a stop that prevents the upper plate 208A from being pushed closer toward the top surface of the opening 203. For example, FIG. 6 illustrates the upper plate 208A as impinging on the end of the upper adjuster 206A. Similarly, the lower adjuster 206B protrudes from the bottom surface of the opening 203 toward the lower plate 208B. The lower adjuster 206B provides a stop that prevents the lower plate 208B from being pushed closer toward the bottom surface of the opening 203. For example, FIG. 6 illustrates the lower plate 208B as being separated from the end of the lower adjuster 206B.

In some embodiments, the distance that the adjusters 206A-B protrude into the opening 203 may be controlled. For example, in some embodiments, the adjusters 206A-B may comprise threaded shafts that extend through similarly threaded holes in the connector 100. In this manner, rotating an adjuster 206A-B raises or lowers that adjuster 206A-B, similar to the operation of a set screw or the like. The adjusters 206A-B may be rotated (e.g. “adjusted”) manually or using a motorized mechanism or the like. The combination of adjusters 206A-B and springs 204A-B allow for precise vertical positioning of inserted fiber arrays. Thus, the vertical position of one or both connected fiber arrays may be adjusted using the adjusters 206A-B to provide more accurate optical alignment between the fiber arrays. The use of threaded adjusters 206A-B as described herein may allow for fine adjustment of the vertical position of a fiber array, in some embodiments. Additionally, the adjusters 206A-B may be “tightened” to press the plates 208A-B against the fiber array and secure the fiber array more firmly, while still allowing removal of the fiber array. In this manner, the combination of upper and lower springs, upper and lower plates, and upper and lower adjusters may be considered a “spring compression device.”

As an example, FIGS. 7A and 7B illustrate cross-sectional views of a connector 200 connecting two fiber arrays 210A-B, in accordance with some embodiments. The view of FIG. 7A is similar to that of FIG. 6, and the view of FIG. 7B is a cross-sectional side view perpendicular to the view of FIG. 7A. The connector 200 of FIGS. 7A-7B allows for the connection of two fiber arrays 210A-B while allowing the vertical alignment of the fiber arrays 210A-B to be adjusted or optimized. Additionally, the connector 200 allows for fiber arrays 210A-B of different dimensions (e.g., thickness) to be connected using the same connector 200 and allows easier alignment of fiber arrays 210A-B having different dimensions. The connector 200 is an illustrative example, and other configurations of connectors using springs, plates, and adjusters are possible.

In the embodiment of FIGS. 7A-7B, the connector 200 comprises a first opening 203A within which a fiber array 210A is inserted for connection, and a second opening 203B within which a fiber array 210B is inserted for connection. The first opening 203A and the second opening 203B may be portions of the same larger opening, and may have similar dimensions or different dimensions. The fiber array 210A is sandwiched between plates 208A-B, which compress the top and bottom of the fiber array 210A due to the compressive force of the springs 204A-B (not illustrated in FIG. 7B). Similarly, fiber array 210B is sandwiched between plates 208C-D, which compress the top and bottom of the fiber array 210B due to the compressive force of springs (not illustrated in FIG. 7B). Adjusters 206A-B may be operated to adjust the vertical position of the fiber array 210A while allowing the compressive force of the springs 204A-B to secure the fiber array 210A. Similarly, adjusters 206C-D may be operated to adjust the vertical position of the fiber array 210B while allowing the compressive force of springs to secure the fiber array 210B. In this manner, after insertion of the fiber arrays 210A-B, the adjusters 206A-D may be utilized to adjust the vertical position of the fiber array 210A and/or the fiber array 210B to optically align the fiber arrays 210A-B more accurately.

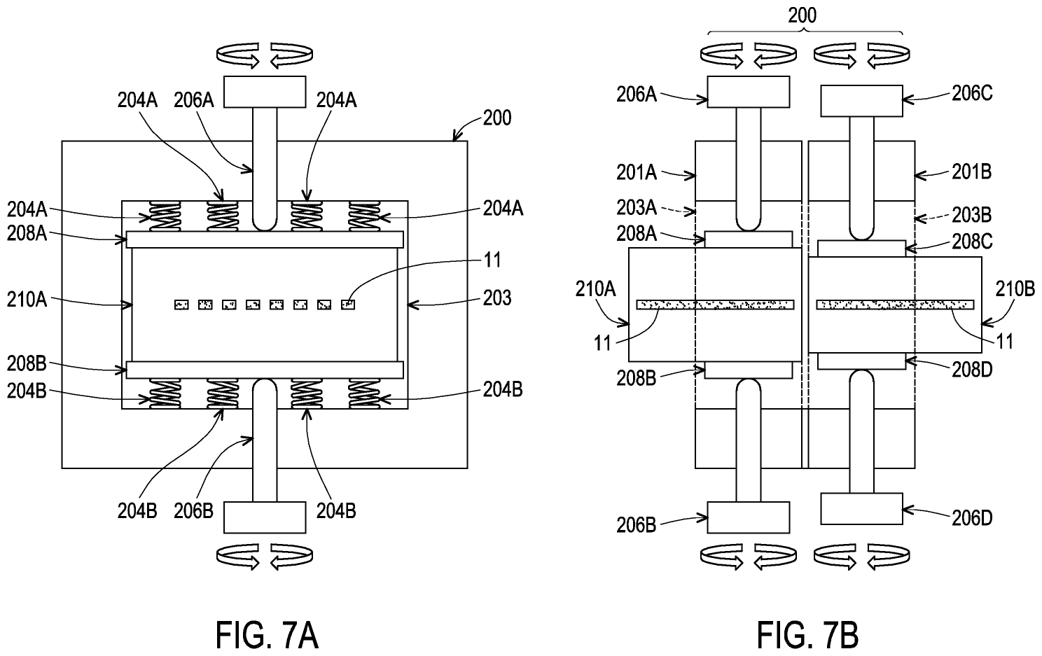

FIG. 8 illustrates a cross-sectional side view of a connector 200 connecting two fiber arrays 210A-B having the same thickness. As shown in FIG. 8, when the inserted fiber arrays 210A-B have the same thickness, a single upper plate 208A and a single lower plate 208B may be used to secure both fiber arrays 210A-B. The connector 200 of FIG. 8 also includes upper springs 204A and lower springs 204B, though they are not illustrated. Additionally, a single upper adjuster 206A and a single lower adjuster 206B may be used to secure and align both fiber arrays 210A-B. For example, in some embodiments, tightening the adjusters 206A-B to press the plates 208A-B against both fiber arrays 210A-B may bring the fiber arrays 210A-B into better optical alignment.

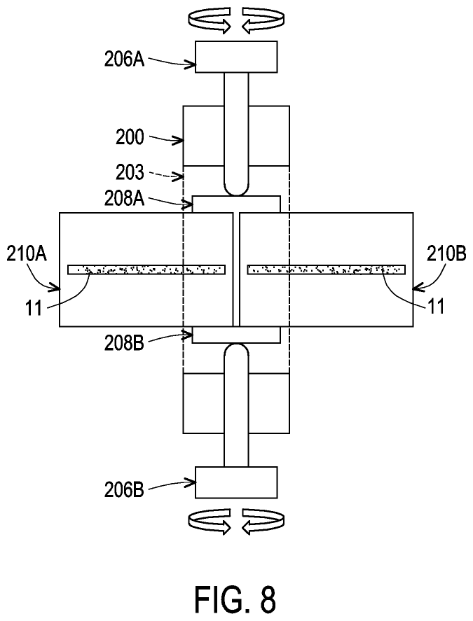

In some embodiments, the magnetic members 102 described for FIGS. 1-5B may be incorporated into a connector 200. Accordingly, magnetic members 12/13 may also be incorporated into fiber arrays 210A-B. As a non-limiting example, FIG. 9 illustrates a cross-sectional view of a connector 250 and a fiber array 260 comprising magnetic members 102/12, in accordance with some embodiments. The view of FIG. 9 is similar to the view of FIG. 7A. The connector 250 may be similar to the connector(s) 200 described previously, except that the connector 250 comprises magnetic members 102A-B at opposite sidewalls of the opening 203. The magnetic members 102A-B may be similar to those described previously for the connector(s) 100, and may have any suitable number or arrangement. The fiber array 260 may be similar to the fiber array 10A. For example, the fiber array 260 comprises magnetic members 12A-B on opposite sidewalls that are attracted to corresponding magnetic members 102A-B during insertion into the connector 250. In this manner, the magnetic members 102/12 may allow for easy alignment and securing of the fiber array 260, and the adjusters 206A-B may allow for adjustment of the alignment of the fiber array 260 to improve accuracy or efficiency. This embodiment also allows for easy removal of the fiber array 260. The connector 250 is an example, and other configurations are possible.

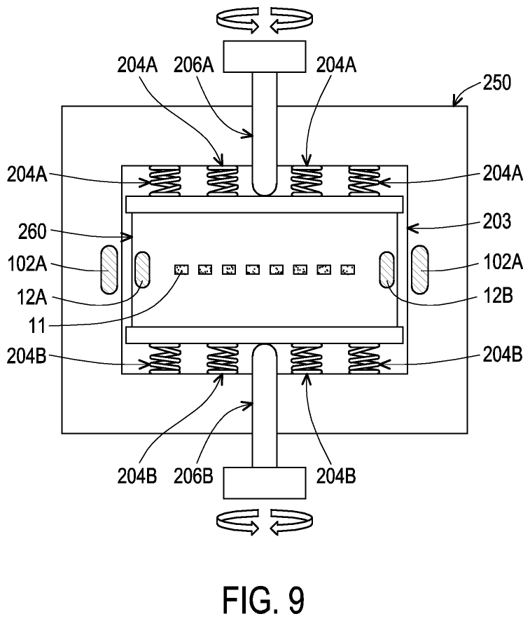

FIGS. 10A and 10B illustrate a side view and a top view of a fiber array structure 300 comprising a fiber array 310 that is optically coupled to a flat connector 350, in accordance with some embodiments. For example, optical signals and/or optical power of optical fibers 311 of the fiber array 310 are optically coupled to corresponding waveguides 351 of the flat connector 350, described in greater detail below. The flat connector 350 comprises magnetic members 352 that facilitate optical coupling of the fiber array 310 to another fiber array, described in greater detail below. The fiber array 310 comprises a plurality of optical fibers 311, similar to the fiber arrays 10 or 210 described above.

In some embodiments, the fiber array structure 300 comprises a coupling region 320 between the fiber array 310 and the flat connector 350. Within the coupling region 320, optical signals and/or optical power are transmitted between each optical fiber 311 and a corresponding waveguide 351 of the flat connector 350. The coupling region 320 may be part of the fiber array 310, in some cases. The coupling region 320 comprises fiber couplers 323 and corresponding waveguide couplers 321. Each fiber coupler 323 is optically coupled to a corresponding optical fiber 311 such that optical signals and/or optical power are transmitted between an optical fiber 311 and its corresponding fiber coupler 323. In some cases, the fiber couplers 323 may be part of or extensions of the optical fibers 311. Each waveguide coupler 321 is optically coupled to a corresponding waveguide 351 such that optical signals and/or optical power are transmitted between a waveguide 351 and its corresponding waveguide coupler 321. In some cases, the waveguide couplers 321 may be part of or extensions of the waveguides 351. Each fiber coupler 323 is located next to a corresponding waveguide coupler 321 such that each fiber coupler 323 is evanescently coupled to that waveguide coupler 321. For example, optical signals and/or optical power may be transmitted between a fiber coupler 323 and its corresponding waveguide coupler 321, as indicated by the arrow in FIG. 10A.

In some embodiments, the flat connector 350 comprises a plurality of waveguides 351, in which each waveguide 351 is optically coupled to a corresponding optical fiber 311 through a corresponding waveguide coupler 321 and a corresponding fiber coupler 323. The waveguides 351 may be arranged in a row or array, in some embodiments. The waveguides 351 may be, for example, slab waveguides, rectangular waveguides, or other suitable waveguides configured to transmit optical signals and/or optical power. The waveguides 351 may be near a coupling surface 353 of the flat connector 350 and may be configured to evanescently couple optical signals and/or optical power through the coupling surface 353 when connected, described in greater detail below. In some embodiments, the flat connector 350 has a thickness that is less than a thickness of the fiber array 310.

In some embodiments, the flat connector 350 comprises one or more magnetic members 352. The magnetic members 352 may attract corresponding magnetic members of another flat connector to connect the flat connectors together and align their waveguides, described in greater detail below. The magnetic members 352 may be adjacent the waveguides 351. For example, in some embodiments, the waveguides 351 may be between two magnetic members 352, as shown in FIG. 10B. The magnetic members 352 may be farther from the coupling surface 353 than the waveguides 351, as shown in FIG. 10A. In other embodiments, the magnetic members 352 may be about as close or closer to the coupling surface 353 than the waveguides 351. The flat connector 350 of FIGS. 10A-10B is an example, and the magnetic members 352 may have another number or arrangement than shown. For example, a flat connector 350 may have a single magnetic member 352 or more than two magnetic members 352.

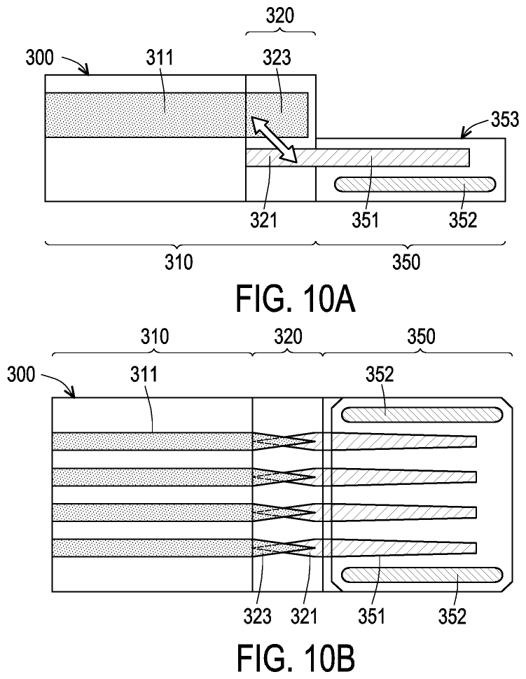

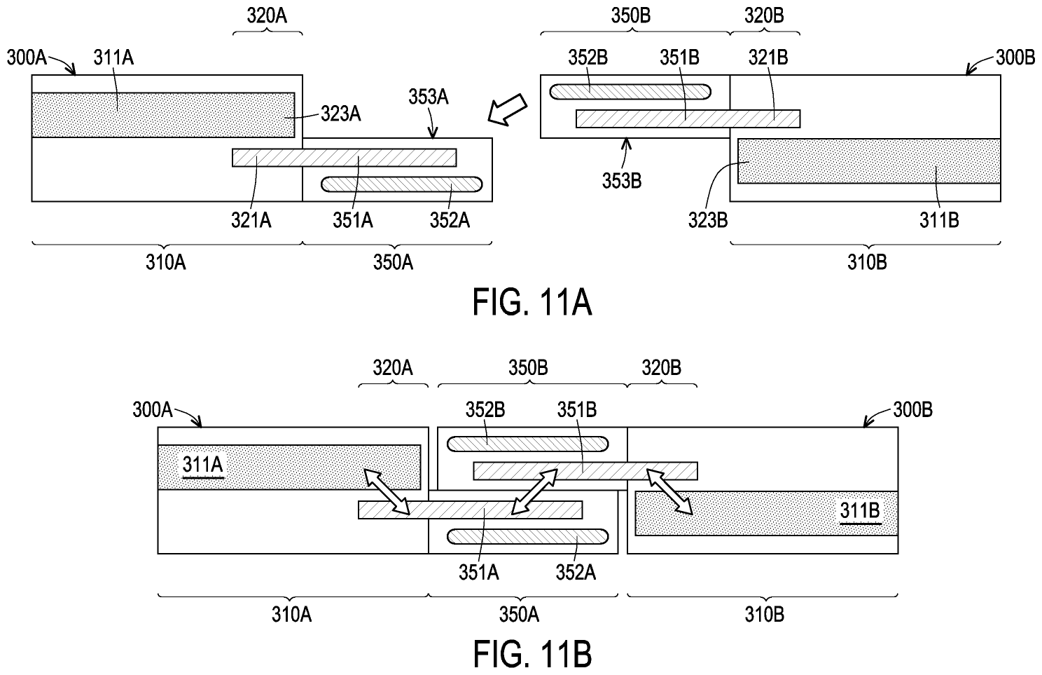

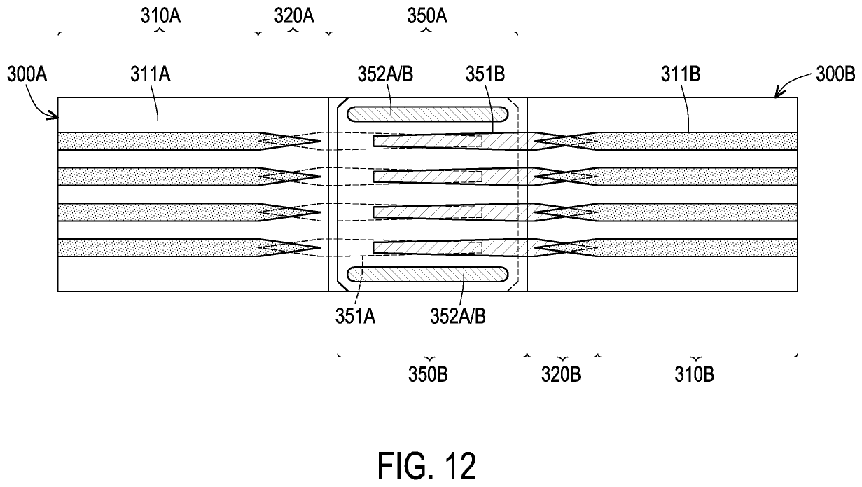

FIGS. 11A and 11B illustrates cross-sectional views of two fiber array structures 300A-B before and after being connected, in accordance with some embodiments. FIG. 12 illustrates a plan view of the fiber array structures 300A-B after being connected. The fiber array structure 300A and the fiber array structure 300B may both be similar to the fiber array structure 300 shown in FIGS. 10A-10B. For example, the fiber array structure 300A has a flat connector 350A comprising magnetic members 352A and waveguides 351A that are optically coupled to optical fibers 311A, and the fiber array structure 300B has a flat connector 350B comprising magnetic members 352B and waveguides 351B that are optically coupled to optical fibers 311B.

When the fiber array structures 300A-B are connected, as shown in FIGS. 11B and 12, the coupling surface 353A of the flat connector 350A is in contact with the coupling surface 353B of the flat connector 350B. When connected, each waveguide 351A is adjacent a corresponding waveguide 351B such that the corresponding waveguides 351A-B are evanescently coupled to each other. Thus, optical signals and/or optical power may be transmitted between a waveguide 351A and a corresponding waveguide 351B. In some cases, the waveguides 351A-B may comprise evanescent couplers or may be considered to be evanescent couplers. In this manner, the optical fibers 311A of the fiber array structure 300A are optically coupled to the optical fibers 311B of the fiber array structure 300B by the flat connectors 350A-B. For example, as shown by the arrows in FIG. 11B, optical signals and/or optical power may be coupled between an optical fiber 311A and a corresponding waveguide 351A, between that waveguide 351A and a corresponding waveguide 351B, and between that waveguide 351B and a corresponding optical fiber 311B. Coupling optical fibers 311A-B using evanescently-coupled waveguides 351A-B as described herein can avoid instabilities or insertion loss due to deviations in the end faces of couplers for end-to-end connections. In addition, the flat connectors 350A-B as described herein can also achieve multi-channel connections or multi-path connections, improving flexibility, reliability, or scalability.

The fiber array structures 300A-B may be connected by bringing the coupling surface 353B of the flat connector 350B into contact with the coupling surface 353A of the flat connector 350A. As the flat connector 350B is brought toward the flat connector 350A, the magnetic members 352B of the flat connector 350B are pulled toward the magnetic members 352A of the flat connector 350A by magnetic attraction. In particular, the magnetic members 352A-B are configured to attract the flat connectors 350A-B to each other such that the waveguides 351A-B are optically aligned when the coupling surfaces 353A-B are in contact. In this manner, the magnetic members 352A-B can facilitate accurate “automatic” alignment of the waveguides 351A-B for evanescent coupling. Additionally, the attraction between the magnetic members 352A-B secures the flat connectors 350A-B to each other while also allowing for the disconnection of the flat connectors 350A-B if desired.

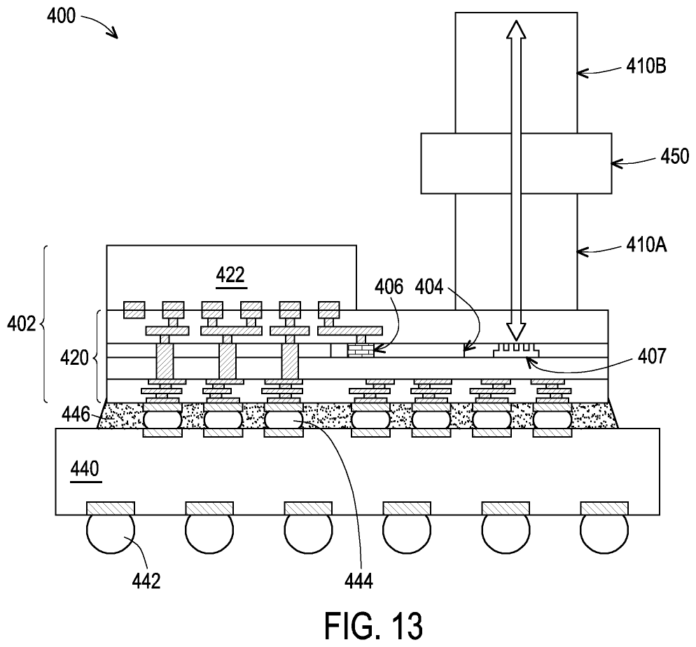

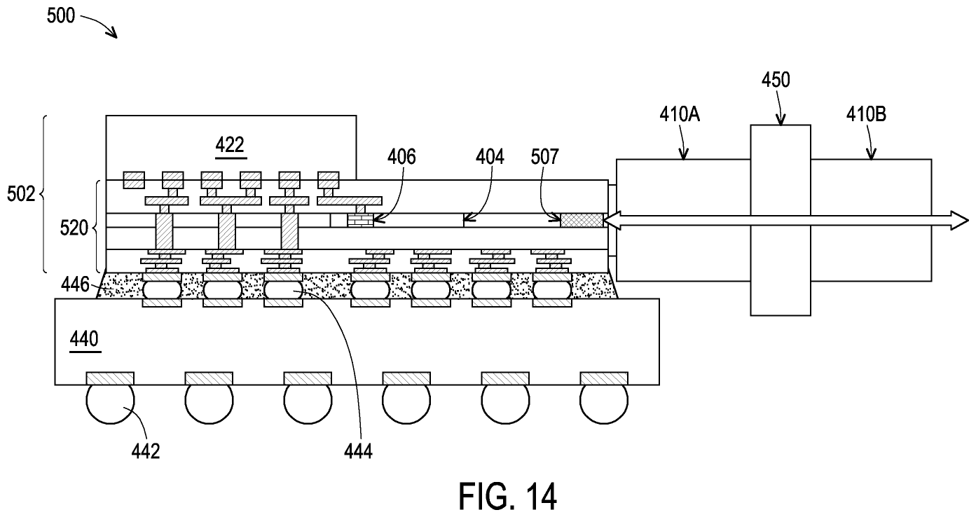

FIGS. 13 and 14 illustrate packages 400 and 500 that are connected to a fiber array by connectors 450, in accordance with some embodiments. The connectors 450 shown in FIGS. 13-14 may be similar to any embodiment connectors described herein, such as connectors 100, 200, 250, or 350. The connectors 450 are utilized to optically couple a first fiber array 410A to a second fiber array 410B, in which the first fiber array 410A is optically coupled to photonic components (e.g., waveguides 404, photonic components 406, or the like) within the package 400/500 and the second fiber array 410B is optically coupled to external components or devices. In the package 400 of FIG. 13, the first fiber array 410A is vertically attached to the package 400 and is optically coupled to the photonic components using a grating coupler 407. In the package 500 of FIG. 14, the first fiber array 410A is horizontally attached to the package 500 and is optically coupled to the photonic components using an edge coupler 507. Similar components or features of the packages 400 and 500 have similar numerical labels, and the descriptions are not repeated. The packages 400 and 500 of FIGS. 13-14 are intended as representative examples of packages that may be connected using connectors described herein, and other packages, components, devices, or configurations thereof may be used in other cases. The use of connectors as described herein can allow the connection between a photonic package and optical fiber to be more reliable, while also improving system transmission speed and efficiency.

Referring to FIG. 13, the package 400 comprises a photonic engine 402 attached to a package substrate 440, in accordance with some embodiments. The photonic engine 402 comprises an electronic die 422 connected to a photonic die 420. The electronic die 422 may be over and bonded to the photonic die 420. In accordance with some embodiments, the electronic die 422 includes integrated circuits for interfacing with the photonic die 420, such as the circuits for controlling the operation of the photonic die 420 or photonic components 406. For example, electronic die 422 may include controllers, drivers, amplifiers, and/or the like, or combinations thereof, and may include Serializer/Deserializer (SerDes) functionality. The corresponding components in electronic die 422 may act as parts of I/O interfaces between optical signals and electrical signals.

The photonic die 420 may include waveguides 404 such as silicon waveguides, silicon nitride waveguides, or other types of waveguides. The photonic die 420 may include photonic components 406 such as modulators, photodetectors, or the like. For example, a photodetector may be optically coupled to the waveguides 404 to detect optical signals within the waveguides 404 and generate electrical signals corresponding to the optical signals. A modulator may be optically coupled to the waveguides 404 to receive electrical signals and generate corresponding optical signals within the waveguides 404 by modulating optical power within the waveguides 404. The photonic die 420 of FIG. 13 also comprises a grating coupler 407 that optically couples the waveguides 404 to the first fiber array 410A. An interconnect structure may be formed over and/or under the waveguides 404 and photonic components 406. Each interconnect structure may include a plurality of dielectric layers and metal lines and vias in the plurality of dielectric layers. In some embodiments, optical signals and/or optical power may be transmitted through dielectric layers of an upper interconnect structure, as shown in FIG. 13. In such embodiments, the first fiber array 410A may be attached to the upper interconnect structure using, for example, an optical glue or the like. Interconnect structures on opposite sides of the photonic die 420 may be electrically interconnected by through-vias. In some embodiments, the electronic die 422 may be bonded to an upper interconnect structure using dielectric-to-dielectric bonding and/or metal-to-metal bonding (e.g., direct bonding, fusion bonding, oxide-to-oxide bonding, hybrid bonding, or the like). In other embodiments, the electronic die 422 may be bonded to an upper interconnect structure using solder bumps or the like.

In some embodiments, conductive connectors 444 are formed on and electrically connected to a lower interconnect structure of the photonic die 420. The conductive connectors 444 may include solder balls, solder bumps, or the like, in some embodiments. For example, the conductive connectors 444 may include ball grid array (BGA) connectors, solder balls, metal pillars, controlled collapse chip connection (C4) bumps, micro bumps, electroless nickel-electroless palladium-immersion gold technique (ENEPIG) formed bumps, or the like. The conductive connectors 444 may include a conductive material such as solder, copper, aluminum, gold, nickel, silver, palladium, tin, the like, or a combination thereof. In some embodiments, the conductive connectors 444 are formed by initially forming a layer of solder through such commonly used methods such as evaporation, electroplating, printing, solder transfer, ball placement, or the like. Once a layer of solder has been formed on the structure, a reflow may be performed in order to shape the material into the desired bump shapes. In another embodiment, the conductive connectors 444 include metal pillars (such as a copper pillar) formed by a sputtering, printing, electro plating, electroless plating, CVD, or the like. The metal pillars may be solder free and have substantially vertical sidewalls. In some embodiments, a metal cap layer (not shown) is formed on the top of the conductive connectors 444. The metal cap layer may include nickel, tin, tin-lead, gold, silver, palladium, indium, nickel-palladium-gold, nickel-gold, the like, or a combination thereof and may be formed by a plating process.

In some embodiments, the package substrate 440 comprises conductive pads, conductive routing, and/or other conductive features that provide interconnections and electrical routing. In some embodiments, the package substrate 440 may comprise an interposer, a semiconductor substrate, a redistribution structure, an interconnect substrate, a core substrate, a printed circuit board (PCB), or the like. In some embodiments, the package substrate 440 comprises active and/or passive devices. In other embodiments, the package substrate 440 is free of active and/or passive devices. In some embodiments, conductive connectors 442 are formed on the package substrate 440, which may be similar to the conductive connectors 444 described above.

In some embodiments, the conductive connectors 444 of the photonic engine 402 are placed on corresponding conductive pads of the package substrate 440 and then a reflow process is performed to bond the photonic engine 402 to the package substrate 440. In this manner, the photonic engine 402 may be electrically connected to the package substrate 440. In other embodiments, the photonic engine 402 may be bonded to the package substrate 440 using dielectric-to-dielectric bonding and/or metal-to-metal bonding. In some embodiments, an underfill 446 may be deposited between the photonic engine 402 and the package substrate 440. In other embodiments, other dies, chips, packages, or the like are also bonded to the package substrate 440. In this manner, the connectors described herein may be utilized to optically couple an external fiber array to a grating coupler of a package. The package 400 shown in FIG. 13 is an example, and the various components of the package 400 may have a different arrangement in other embodiments.

Referring to FIG. 14, the package 500 comprises a photonic engine 502 attached to a package substrate 440, in accordance with some embodiments. The photonic engine 502 is similar to the photonic engine 402 of FIG. 13, except that the photonic engine 502 comprises a photonic die 520 that comprises an edge coupler 507 instead of a grating coupler 407. The edge coupler 507 optically couples the waveguides 404 of the photonic die 520 to the first fiber array 410A. Accordingly, the first fiber array 410A is attached to a sidewall of the photonic die 520 (e.g., using an optical glue or the like) to be optically coupled to the edge coupler 507. In this manner, the connectors described herein may be utilized to optically couple an external fiber array to an edge coupler of a package. The package 500 shown in FIG. 14 is an example, and the various components of the package 500 may have a different arrangement in other embodiments.

The embodiments of the present disclosure have some advantageous features. The connectors described herein allow for two fiber arrays (or other optical fiber components) to be connected with improved accuracy. The connectors described herein utilize springs, magnets, or a combination thereof to ensure the stability and precision of the connection. In some cases, the connectors described herein allow for the fiber arrays to be automatically aligned with a high accuracy. Some embodiments describe adjusters that may be utilized to adjust the alignment of the connected fiber arrays to improve coupling efficiency and reduce insertion loss. Additionally, the connectors described herein allow for the secure connection of fiber arrays while also allowing for the fiber arrays to be removed and disconnected. This can improve the ease of repair or replacement of fiber arrays, and thus can reduce maintenance time and cost. The connectors described herein are thus modular connectors, facilitating easy disassembly and repair. The automatic correction and connection features of the connectors described herein can reduce human errors, increase stability, and increase reliability of a photonic system. The connectors described herein may also be compatible with different types of optical fiber, including the connection of different types, which thus increases the diversity and application range of a photonic system.

In accordance with an embodiment of the present disclosure, a device includes a first fiber array that includes first optical fibers and first magnetic members; a second fiber array that includes second optical fibers and second magnetic members; and a connector including third magnetic members adjacent an opening, wherein the opening extends from a first side of the connector to a second side of the connector, wherein the first magnetic members of the first fiber array correspond to third magnetic members near the first side, wherein the second magnetic members of the second fiber array correspond to third magnetic members near the second side. In an embodiment, the first magnetic members are located on opposite vertical sidewalls of the first fiber array and the third magnetic members are located on opposite vertical sidewalls of the opening. In an embodiment, the third magnetic members include a first set of third magnetic members located near the first side and a second set of third magnetic members located near the second side. In an embodiment, the first fiber array has a different thickness than the second fiber array. In an embodiment, the connector is ring-shaped. In an embodiment, the first magnetic members are at least partially within the opening. In an embodiment, the first fiber array is optically coupled to a grating coupler of a photonic die. In an embodiment, the first fiber array is optically coupled to an edge coupler of a photonic die.

In accordance with an embodiment of the present disclosure, a device includes a ring-shaped connector including an opening, a first alignment member at a first side of the opening and a second alignment member at a second side of the opening, wherein the opening is shaped to receive a first fiber array in the first side and a second fiber array in the second side, wherein the first alignment member is configured to align the first fiber array within the opening, wherein the second alignment member is configured to align the second fiber array within the opening. In an embodiment, the first alignment member includes a first plate mechanically connected to a first surface of the opening by at least one first spring. In an embodiment, the first alignment member further includes a second plate mechanically connected to a second surface of the opening by at least one second spring. In an embodiment, the first alignment member includes a threaded shaft rotatably extending through the ring-shaped connector to the first plate. In an embodiment, the first alignment member includes a magnetic member. In an embodiment, the first alignment member includes a first magnet and the second alignment member includes a second magnet. In an embodiment, the first fiber array includes a third magnet that corresponds to the first magnet.

In accordance with an embodiment of the present disclosure, a method includes bringing an end of a first fiber array near an end of a second fiber array, wherein the first fiber array includes a first magnet and the second fiber array includes a second magnet; magnetically attracting the first magnet to a third magnet to align the end of the first fiber array to the end of the second fiber array; and magnetically attracting the second magnet to a fourth magnet to align the end of the second fiber array to the end of the first fiber array. In an embodiment, bringing the end of a first fiber array near the end of a second fiber array includes inserting the end of the first fiber array and the end of the second fiber array into a ring-shaped connector, wherein the ring-shaped connector includes the third magnet and the fourth magnet. In an embodiment, magnetically attracting the first magnet to the third magnet aligns an end of a first optical fiber within the first fiber array to an end of a second optical fiber within the second fiber array. In an embodiment, the first fiber array includes the fourth magnet and the second fiber array includes the third magnet. In an embodiment, magnetically attracting the first magnet to the third magnet aligns a first evanescent coupler within the first fiber array to a second evanescent coupler within the second fiber array

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A device comprising:
a first fiber array comprising a plurality of first optical fibers and a plurality of first magnetic members;
a second fiber array comprising a plurality of second optical fibers and a plurality of second magnetic members; and
a connector comprising a plurality of third magnetic members adjacent an opening, wherein the opening extends from a first side of the connector to a second side of the connector, wherein the first magnetic members of the first fiber array correspond to third magnetic members near the first side, wherein the second magnetic members of the second fiber array correspond to third magnetic members near the second side.

2. The device of claim 1, wherein the first magnetic members are located on opposite vertical sidewalls of the first fiber array and the third magnetic members are located on opposite vertical sidewalls of the opening.

3. The device of claim 1, wherein the plurality of third magnetic members comprise a first set of third magnetic members located near the first side and a second set of third magnetic members located near the second side.

4. The device of claim 1, wherein the first fiber array has a different thickness than the second fiber array.

5. The device of claim 1, wherein the connector is ring-shaped.

6. The device of claim 1, wherein the plurality of first magnetic members are at least partially within the opening.

7. The device of claim 1, wherein the first fiber array is optically coupled to a grating coupler of a photonic die.

8. The device of claim 1, wherein the first fiber array is optically coupled to an edge coupler of a photonic die.

9. A device comprising:
a ring-shaped connector comprising an opening, a first alignment member at a first side of the opening and a second alignment member at a second side of the opening, wherein the opening is shaped to receive a first fiber array in the first side and a second fiber array in the second side, wherein the first alignment member is configured to align the first fiber array within the opening, wherein the second alignment member is configured to align the second fiber array within the opening.

10. The device of claim 9, wherein the first alignment member comprises a first plate mechanically connected to a first surface of the opening by at least one first spring.

11. The device of claim 10, wherein the first alignment member further comprises a second plate mechanically connected to a second surface of the opening by at least one second spring.

12. The device of claim 10, wherein the first alignment member comprises a threaded shaft rotatably extending through the ring-shaped connector to the first plate.

13. The device of claim 9, wherein the first alignment member further comprises a magnetic member.

14. The device of claim 9, wherein the first alignment member comprises a first magnet and the second alignment member comprises a second magnet.

15. The device of claim 14, wherein the first fiber array comprises a third magnet that corresponds to the first magnet.

16. A method comprising:
bringing an end of a first fiber array near an end of a second fiber array, wherein the first fiber array comprises a first magnet and the second fiber array comprises a second magnet;
magnetically attracting the first magnet to a third magnet to align the end of the first fiber array to the end of the second fiber array; and
magnetically attracting the second magnet to a fourth magnet to align the end of the second fiber array to the end of the first fiber array.

17. The method of claim 16, wherein bringing the end of a first fiber array near the end of a second fiber array comprises inserting the end of the first fiber array and the end of the second fiber array into a ring-shaped connector, wherein the ring-shaped connector comprises the third magnet and the fourth magnet.

18. The method of claim 17, wherein magnetically attracting the first magnet to the third magnet aligns an end of a first optical fiber within the first fiber array to an end of a second optical fiber within the second fiber array.

19. The method of claim 16, wherein the first fiber array comprises the fourth magnet and the second fiber array comprises the third magnet.

20. The method of claim 19, wherein magnetically attracting the first magnet to the third magnet aligns a first evanescent coupler within the first fiber array to a second evanescent coupler within the second fiber array.
